(19) United States
(12) Patent Application Publication
(10) Pub. No.: US 2021/0374794 A1
(43) Pub. Date: Dec. 2, 2021

(54) SYSTEM AND METHOD FOR IMPLEMENTING A ONE-STOP ADVERTISING CAMPAIGN THROUGH A NON-DIGITAL ADVERTISING MEDIUM

(71) Applicant: Nishant Shah, Aurora, IL (US)

(72) Inventor: Nishant Shah, Aurora, IL (US)

(21) Appl. No.: 16/882,838

(22) Filed: May 26, 2020

(51) Int. Cl. G06Q 30/02; G06Q 10/06; G06Q 20/08; G01P 13/00; G01S 19/01

(52) U.S. Cl. CPC G06Q 30/0246; G06Q 30/0273; G06Q 30/0265; G06Q 30/0264; G09F 15/0037; G06Q 20/085; G06Q 30/0272; G01P 13/00; G01S 19/01; G06Q 10/063112

(57) ABSTRACT

A system and method for implementing a one-stop advertising campaign through a non-digital advertising medium provides a single platform for an advertiser to implement an advertisement on a non-digital advertising medium. The advertiser, through a one-click functionality on the platform, selects the advertising medium, the advertising-related workers to implement the advertisement, the advertising costs, and the timeline for advertising on the advertising medium. One or more advertising-related workers upload skill sets and fees for the advertiser to review before selecting. The system generates recommendations of appropriate workers to implement the advertisement campaign based on needs of the advertiser. The system also integrates sensors and/or positioning systems into the advertising media to detect the numbers, physical features, relative position, and movement pattern of consumers in proximity to the advertising medium. This allows a processor and algorithms to generate consumer data useful to the advertiser for marketing and setting advertising costs.

### CROSS-REFERENCE

None.

### FIELD OF THE DISCLOSURE

The present disclosure relates to a system and method for implementing a one-stop advertising campaign through advertising medium, including, at least, non-digital advertising medium, and more particularly, to a system and method that provides a single platform for an advertiser to implement an advertisement on a non-digital advertising medium with one-click functionality from the platform, including selecting: the advertising medium, the advertising-related workers, the advertising costs, and the timeline for advertising on the advertising medium; and further provides recommendations of appropriate workers to implement the advertisement campaign based on needs of the advertiser and working parameters of the workers; and further integrates sensors and/or positioning systems into the advertising media to detect the numbers, physical features, relative position, and movement pattern of consumers in proximity to the advertising medium, whereby a processor and algorithm generate consumer data from the sensors useful to the advertiser for marketing and setting advertising costs.

### BACKGROUND

Typically, an advertising campaign involves a specifically designed strategy that is carried out across different advertising media to both achieve results and to increase brand awareness, sales and communication within a specific market. Often, the success of an advertising campaign depends on optimizing an advertising budget to advertise so as to maximally influence audience behavior. For example, if a campaign is directed to selling a service, the advertiser seeks to use a given budget to purchase advertising. The allows a maximum amount of consumers to purchase the service. Determining how to efficiently and optimally spend an advertising budget, as well as implementing and managing an ongoing advertising campaign utilizing such a budget, however, can pose a daunting challenge to advertisers.

Generally, a billboard is a large, static signage that displays advertising messages consisting of a combination of text and graphics. Traditionally, the message has been provided by way of fixed sheets that are pasted to a backing. This traditional approach suffers from the inability to quickly change the displayed message since it requires the use of a crew to change the message. It is known in the art that roadside billboards are effective for displaying advertisements. In general, roadside billboards are fixed at a location, so that drivers and other passersby generally have the opportunity to view them.

Accordingly, a need exists for a system and method for implementing a one-stop advertising campaign through at least one non-digital advertising medium that provides a single platform for an advertiser to implement an advertisement on a non-digital advertising medium. The advertiser, through a one-click functionality on the platform, selects one or more of advertising medium, the advertising-related workers to implement the advertisement, the advertising costs, and the timeline for advertising on the advertising medium. One or more advertising-related workers upload skill sets and fees for the advertiser to review before selecting. The system generates recommendations of appropriate workers to implement the advertisement campaign based on needs of the advertiser. The need also exists for a system and method that integrates sensors and/or positioning systems into the advertising media to detect the numbers, physical features, relative position, and movement pattern of consumers in proximity to the advertising medium. This allows a processor and algorithms to generate consumer data useful to the advertiser for marketing and setting advertising costs.

### OBJECTS OF THE DISCLOSURE

It is an object of the disclosure to provide a one-stop platform for purchasing advertising on at least non-digital advertising medium.

It is another object of the disclosure to allow the advertiser to implement the advertising campaign with a few clicks on a networked application; such as a software application or a website.

It is another object of the disclosure to allow advertising-related workers to upload skill sets and fees for implementing advertisements on non-digital advertising medium.

It is another object of the disclosure to generate recommendations of appropriate workers to implement the advertisement campaign based on needs of the advertiser.

It is another object of the disclosure to provide an easy, one-stop interface to the advertiser for budgeting the cost of the advertising campaign.

It is another object of the disclosure to detect the numbers, physical features, relative position, and movement pattern of consumers in proximity to the advertising medium.

It is another object of the disclosure to provide consumer data useful to the advertiser for marketing and setting advertising costs.

It is another object of the disclosure to allow the advertiser to enhance marketing campaigns with real time consumer data.

It is another object of the disclosure to provide an easy to use system and method for implementing a one-stop advertising campaign through a non-digital advertising medium.

Other advantages of this disclosure will be clear to a person of ordinary skill in the art. It should be understood, however, that a system, an apparatus or a method could practice the disclosure while not achieving all of the enumerated advantages, and that the claims define the scope of the protected disclosure.

### SUMMARY OF THE DISCLOSURE

The present disclosure provides a system and method for implementing one-stop advertising campaign through at least non-digital advertising medium. Aspects of the present disclosure address one or more of the objectives mentioned above by describing a system and method for implementing a one-stop advertising through at least non-digital advertising medium. The following presents a much-simplified summary of the disclosure in order to provide a basic understanding of some aspects of the systems and methods for creating multiple video streams out of a single master video stream. This summary is not intended to identify key or critical elements or aspects of the disclosure, nor is it intended to set forth or delineate the scope of the claims of this application for patent. The following summary merely presents some of the concepts of the disclosure in a simplified form as a prelude to the more detailed description provided below.

The system and method for implementing a one-stop advertising campaign through a non-digital advertising medium provides a single platform for an advertiser to implement an advertisement on a non-digital advertising medium. In essence, the advertiser completes the entire advertising campaign on an intuitive interface through the platform by making a few strategic selections, including; selecting from at least one advertising medium to carry an advertisement, selecting from one or more workers to implement the advertisement on the advertising medium, receiving recommendations for appropriate workers to implement the advertisement based on working parameters of the workers and needs of the advertiser, scheduling a timeline for the implementation of the advertisement, and budgeting the cost of the advertising campaign.

The system and method also provides the advertiser with an intelligent marketing capacity, so that the advertiser can implement optimal marketing strategies through the non-digital advertising medium. For this purpose, a sensor and/or a positioning system are integrated in the advertising medium to track the numbers, physical features, relative position, and movement pattern of the consumers in relation to the advertising medium. This detected information is synthesized through an algorithm to generate consumer data that is useful for the advertiser in determining advertising effectiveness, advertising costs, and marketing strategies.

In one possible embodiment, the method for implementing a one-stop advertising campaign through an advertising medium comprises an initial Step of providing a platform for initiating an advertising campaign. The platform may utilize a simple graphical user interface that allows the advertiser to control all functions from a personal communication device.

Another Step may include producing, by an advertiser, an advertisement. The advertisement may include, for example, a corporate product or service for sale to the public, or businesses. The advertisement may have ornamental aspects, including various logos, trademarks, colors, and patterns. The advertisement can be tailored to fit on an advertising medium, as described below.

Another Step may include providing at least one advertising medium, the advertising medium configured to display the advertisement. The advertising medium may include a non-digital advertising medium, such as a billboard, park bench, or vehicle (taxi).

The method also includes a Step of offering, by one or more advertisement-related workers, multiple working parameters. The workers are skilled at implementing numerous aspects of an advertising campaign for both non-digital, and digital display.

In some embodiments, a Step comprises viewing, by the advertiser, the advertising medium and the working parameters of the advertisement-related workers. Through the platform, the advertiser views a plurality of advertising media having different configurations and located in different regions. The viewer also views the different skill sets and fees offered by the workers.

Another Step includes recommending one or more of the advertisement-related workers to implement the advertisement, the recommendation being based, at least partially, on the advertisement, the advertising medium, and the working parameters of the advertisement-related workers. The recommendation is based on numerous factors, and may be made by an algorithm, artificial intelligence such as a simple expert system, or a human with a checklist.

In yet another embodiment of the method, a Step includes setting an advertising cost for displaying the advertisement on the advertising medium, the advertising cost being based, at least partially, on the advertisement, the advertising medium, and the working parameters of the advertisement-related workers. In general, the number and type of advertising medium, the region of the advertising medium, and the number and type of consumers in proximity to the advertising medium, substantially dictate the advertising cost. The advertiser is given different baskets of advertising costs, depending on the selected advertising medium and advertisement-related workers.

Another Step comprises selecting, by the advertiser, the advertising medium and the one or more advertisement-related workers.

Yet another Step comprises displaying the advertisement on the advertising medium. The advertiser may, for example, upload, through the platform, an advertisement to display on the selected advertising medium, and with the selected one or more advertisement-related workers.

In an additional embodiment of the disclosed advertising method, the advertising medium comprises a combination of at least one non-digital advertising medium and one digital advertising medium.

In an additional embodiment of the disclosed advertising method, the non-digital advertising medium includes at least one of the following: a billboard, a bench backrest, a vehicle, and a building.

In an additional embodiment of the disclosed advertising method, the working parameters of the advertisement-related workers include at least one of the following: a skill set, a fee, a date of availability schedule, and an availability in a region.

In an additional embodiment of the disclosed advertising method, the one or more advertisement-related workers include at least one of the following: a printer, a painter, a sign worker, a digital sign programmer, and a sensor installation technician.

In an additional embodiment of the disclosed advertising method, the method further comprises a Step of paying, by the advertiser, the advertising cost.

In an additional embodiment of the disclosed advertising method, the method further comprises a Step of scheduling, by the advertiser, a timeline for displaying the advertisement on the advertising medium.

In an additional embodiment of the disclosed advertising method, the method further comprises a Step of integrating a sensor in the advertising medium. The sensor is configured to recognize the type, number, and moving pattern of the potential consumers. Eclectic typers of sensors may be used, so as to create an intelligent advertising medium, generally non-digital before integration of the sensor.

In an additional embodiment of the disclosed advertising method, the method further comprises a Step of detecting, with the sensor, one or more consumers relative to the advertising medium. The sensor may utilize motion, body heat, speed, and facial recognition software to record the potential consumers. A processor and a marketing algorithm may further synthesize the collected information from the consumers to generate a consumer data, as discussed below.

In an additional embodiment of the disclosed advertising method, the method further comprises a Step of generating, from the detected consumers, a consumer data, the consumer data being indicative of the numbers, physical features, relative position, and movement pattern of the consumers. The consumer data may be sold, or synthesized for marketing purposes.

In an additional embodiment of the disclosed advertising method, the method further comprises a Step of monitoring, by the advertiser the consumer data. The advertiser is given access to the consumer data. In this manner, the advertiser can perform a final Step of discerning the effectiveness of the advertisement based on the consumer data.

In an additional embodiment of the disclosed advertising method, the method further comprises a Step of setting an advertising cost for displaying the advertisement on the advertising medium, the advertising cost being based, at least partially, on the advertisement, the advertising medium, the working parameters of the advertisement-related workers, and the consumer data.

In an additional embodiment of the disclosed advertising method, the sensor includes at least one of the following: a counter, a motion detector, a camera, a microphone, and a processor operable with a facial recognition software.

In an additional embodiment of the disclosed advertising method, the method further comprises a Step of integrating a positioning system in the advertising medium.

In an additional embodiment of the disclosed advertising method, the method further comprises a Step of detecting, with the positioning system, one or more consumers relative to the advertising medium. Thus, as the advertising medium moves through a region, the advertising cost increases or decreases based on variable from the consumer.

In an additional embodiment of the disclosed advertising method, the method further comprises a Step of selecting, by the advertiser, the advertising medium and the one or more advertisement-related workers, the selections being performed from the platform.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

Although the characteristic features of this disclosure will be particularly pointed out in the claims, the disclosed method and system, and how it may be made and used, may be better understood by referring to the following description taken in connection with the accompanying drawings forming a part hereof, wherein like reference numerals refer to like parts throughout the several views and in which:

FIG. 1 is a block diagram of an exemplary system for implementing a one-stop advertising campaign through a non-digital advertising medium disclosed herein.

FIGS. 2A-2B are flowcharts of an exemplary method for implementing a one-stop advertising campaign through a non-digital advertising medium disclosed herein.

FIG. 3 is a flowchart of an exemplary worker method for one or more advertisement-related workers to implement an advertisement disclosed therein.

FIG. 4 is a flowchart of an exemplary proprietor method for offering an advertising medium on a platform disclosed therein.

FIGS. 5A-5B are exemplary global positioning systems integrated in a mobile advertising medium, where FIG. 5A shows a mobile advertising medium carrying an advertisement, and FIG. 5B shows a global positioning system tracking the mobile advertising medium disclosed therein.

FIG. 6 is a schematic diagram of an exemplary system for integrating the advertiser, workers, and proprietor on a single one-stop platform disclosed therein.

FIG. 7 are various types of sensors operatively connected to a database and processor disclosed therein.

A person of ordinary skills in the art will appreciate that elements of the figures above are illustrated for simplicity and clarity and are not necessarily drawn to scale. The dimensions of some elements in the figures may have been exaggerated relative to other elements to help to understand the present teachings. Furthermore, a particular order in which certain elements, parts, components, modules, steps, actions, events and/or processes are described or illustrated may not be required. A person of ordinary skills in the art will appreciate that, for simplicity and clarity of illustration, some commonly known and well-understood elements that are useful and/or necessary in a commercially feasible embodiment may not be depicted to provide a clear view of various embodiments per the present teachings.

### DETAILED DESCRIPTION

In the following description of various examples of embodiments of the disclosed system 100 and method 200, reference is made to the accompanying drawings, which form a part hereof, and in which are shown by way of illustration various example devices, systems, and environments in which aspects of the disclosed system and method can be practiced. Other specific arrangements of parts, example devices, systems, and environments, can be used, and structural modifications and functional modifications can be made without departing from the scope of the disclosed system and method.

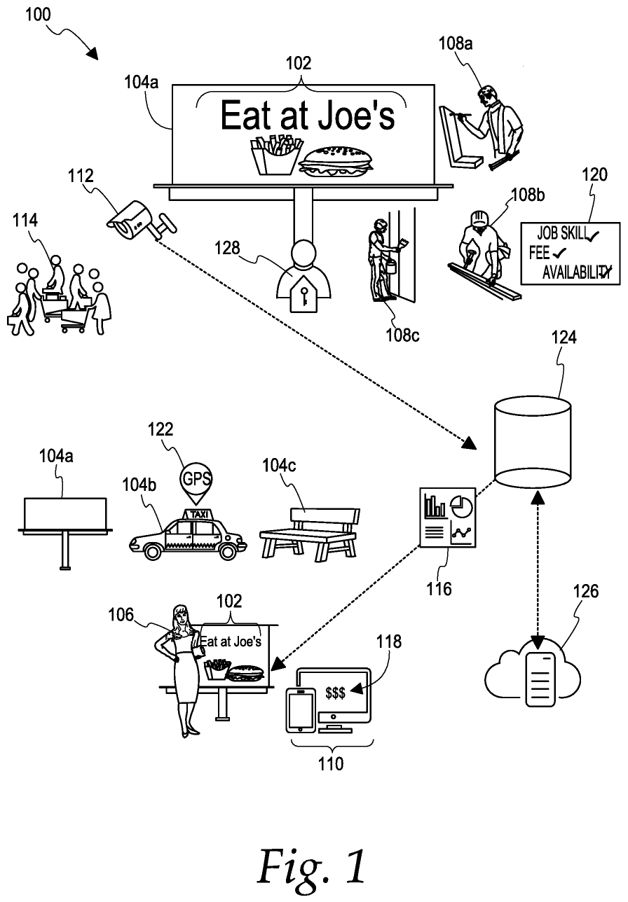

Turning to FIG. 1 in particular, a system 100 for implementing one-stop advertising campaign through a non-digital advertising medium provides a single platform 110 for an advertiser 106 to implement an advertisement 102 campaign. Those skilled in the art will recognize that utilization of a single platform 110 to control an advertising campaign serves to create a one-click system that simplifies the advertising process.

Looking again at FIG. 1, the system 100 comprises a platform 110 that is accessible by an advertiser 106 to implement an advertising campaign on an advertising medium 104a-c. The platform 110 can be accessed by a communication device of the advertiser 106, such as a smart phone, laptop, tablet, computer, and the like. The advertiser 106 may be a small business owner, an advertising executive, a member of an organization, and any person or entity having a need to market a product or service. The platform 110 provides an intuitive means for selecting the desired advertising components, such as the advertising medium 104a-c, advertising-related workers 108a-c, advertising timeline, and advertising cost budgeting. For example, the advertiser 106 can select the advertising medium 104a, view credentials and choose from one or more advertising-related workers 108a-c to implement the advertisement 102, control advertising costs 118, and schedule timelines for the advertising campaign. In the present embodiment, these functions are performed from the platform 110. Such simplification can be useful for advertising novices, or even ad executives who are rushed for time.

The platform 110 may include a network, such as a website or a software application. A graphical user interface displayed on a communication device may be utilized for accessing the platform 110. In one non-limiting embodiment, the platform 110 is an environment in which a piece of software is executed. In other embodiments, the platform 110 is the hardware or the operating system (OS), a web browser and associated application programming interfaces, or other underlying software, as long as the program code is executed with it.

The system 100 is configured to service an advertisement 102 that is produced by the advertiser 106, and enable efficient implementation of the advertisement 102 on the non-digital advertising medium 104a-c. In one exemplary usage, the advertiser 106 creates original advertising content. In another embodiment, the advertiser 106 purchases the advertisement content from a marketing agency. In yet other embodiments, the advertisement 102 may have ornamental aspects, including various logos, trademarks, colors, and patterns. The advertisement 102 may include detachable coupons, audible discount codes, videos, actors, and other advertising means known in the art.

The system 100 allows for displaying the advertisement 102 on at least one advertising medium 104a-c. The advertising medium 104a-c will generally include at least one non-digital advertising medium, such as a billboard 104a, a bench backrest 104c, a vehicle 104b, or a building, but can also include digital advertising medium such as, for example, a digital billboard or an Internet search engine campaign. Thus, the advertising medium 104a-c may be static (wall, signage) or mobile (taxi). However, in alternative embodiments, the system 100 may be used to implement the advertisement 102 on entirely digital or online advertising medium 104a-c, such as a website, a software application, a lighted billboard, and the like. Other examples of non-digital advertising media can include: an in-store display, a mall display, a side of a building, a side of a bus, a side of a car, an airplane banner, a drone, and signage at a religious gathering, a concert, and a stadium.

The system 100 allows the advertiser 106 (or an event organizer) to choose from one, or multiple advertising media for display of the advertisement 102. The advertiser 106 may also choose from advertising media in different regions, having different configurations, and carrying various graphical depictions of the advertisement 102. Eclectic types, shapes, and functions of advertising media may be utilized with the system 100. For example, an event organizer may publish/display the advertisement 102 in a religious building or gathering, and in a sports activity in a private or public stadium where:

a) The event organizer can publish the advertisement 102 at sporting events, at the location of billboards, through flyers, etc. Also the amount of spectators expected is known. The event organizer can also share the number of people at the event based on a ML/Vision Tool, known in the art; or based on tickets sales. This data can be used to price the tickets accordingly.

b) The event organizer can make determinations of how and when to publish the advertisement 102 based on previous events. The event organizer can figure out the increase in sales during the event. Also, after the completion of the event, the increase in sales during or after the event is also determined by the advertiser 106.

In yet another example of how the advertisement 102 can be displayed or distributed for consumption, the advertiser 106 (or event organizer) can make advertising spots available for a book or magazine that is near publishing. The advertising spots can include the steps of distributing information about a publishing event description. Additional steps can include distributing information about who, and how many potential geographically located consumers are participating in the publishing event. Furthermore, coding for the publishing event may be used to help quantify success of the advertisement 102. This can help the advertiser 106 determine if sales have increased, which results in optimal return on investments (ROI).

In order to implement the advertisement 102, the system 100 leverages the skill set of one or more advertisement-related workers 108a-c. The workers 108a-c are operable to implement the advertisement 102 on the non-digital advertising medium in an efficient manner, and as the advertiser 106 requires. The workers 108a-c may be humans or robots.

The workers 108a-c offer multiple working parameters 120 viewable on the platform 110, or a network accessed by the advertiser. The working parameters 120 are available for the advertiser 106 to view and select from. In some embodiments, the working parameters 120 of the workers 108a-c may include, without limitation, a skill set, a fee, a date of availability schedule, and an availability in a region. For example, a worker may upload onto a network parameters indicating: Signage Construction charging $20 per hour, and available March 15 through March 25 in the Chicago area. In another example, a worker offers the parameters: Logo and Design Artist available to paint logos on park benches. Available everyday before noon in Springfield, Ill. The advertiser 106 can view these selections and select as needed.

However, in some embodiments, the system 100 makes recommendations to the advertiser 106 in regards to the appropriate workers 108a-c. The recommendations may be generated through an algorithm, or artificial intelligence software, such as a simple expert system (discussed below), or simply humans who use a checklist or a simple matching program to make the recommendations for an appropriate worker. An expert system could look at, for example, the number of times that a worker successfully implemented a project on the exact medium selected by the advertiser, or on media that is similar to the medium selected by the advertiser, as well as at the customer ratings (see below) for the worker's work product. In other embodiments, the recommendations for the most appropriate worker are based on the type of advertisement 102, the type and location of the advertising medium 104a-c, and the working parameters 120 offered by the workers 108a-c. For example, a small drug store owner, requiring local advertising, receives a recommendation to utilize the services of a local paint shop that draws logos and simple advertisements on park benches for a reduced rate. Or, a multi-national corporation may receive a recommendation to utilize a nationwide billboard advertising agency that employees billboard painters in many regions across the country.

In an alternative embodiment, the system 100 utilizes a unique push-pull process to optimize distribution of the advertisement; to optimize use of the labor/skill-set necessary to display the advertisement; and to enhance communications between the advertising medium proprietor 128 (asset owner), the advertiser 106, and the advertisement-related workers 108a-c.

In one embodiment of a “pull” process, allows the advertising medium proprietor 128 (asset owner) and the advertiser 106 to control assets and labor utilized to create and display an advertisement. For example, the advertising medium proprietor 128 views a desired advertiser 106, and then “pulls” the advertiser 106 for purposes of selling their assets to an appropriate advertiser 106. Further down the line, the advertiser 106 reviews listed advertisement-related workers 108a-c, and then “pulls” an appropriate advertisement-related workers 108a-c, i.e., painter, and/or asset, i.e., billboard. By pulling a desired painter or billboard, for example, the advertiser 106 can select the most appropriate and custom tailored advertising campaign.

In another embodiment a “push” process, allows the advertising medium proprietor 128 (asset owner) and the advertiser 106 push through notifications to achieve a desired advertising arrangement. For example, the advertising medium proprietor 128 “pushes”, or lists, the property or asset. The asset is made viewable on the network, which is accessible by all parties. The advertisement-related workers 108a-c (painter) may then receive push notifications about the assets based on the region and type of work listed by the advertisement-related workers 108a-c. Continuing with the “push” process, once the advertiser 106 lists a wishlist or type of work they want to publish; the advertising medium proprietor 128 and/or the advertisement-related workers 108a-c receive a “push” notification indicating the type of work that is requested by the advertiser 106. Consequently, the advertising medium proprietor 128 and the advertisement-related workers 108a-c can then send a quote or contact information with their past experience and type/number of reviews they have received. They, in essence “push” their asset or skill set in front of the advertiser 106. Thus, the push-pull process expedites the communications and display of available assets, advertisements, and skill sets on the network by allowing the desired asset and/or skill set to be pulled for selection, or pushed onto the network for access by all parties.

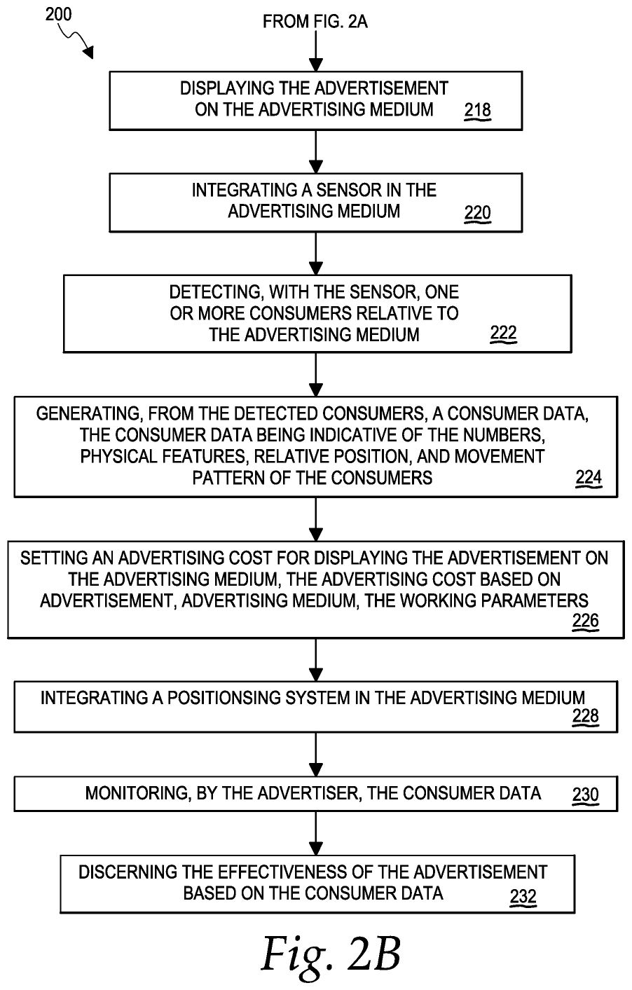

An exemplary flowchart of a worker method 300 for one or more advertisement-related workers 108a-c to implement an advertisement, from the point of view of the workers, is referenced in FIG. 3. The workers 108a-c have an objective of offering an advertisement-related service, and collecting payment for implementation of the advertiser's advertisement 102 through the same one-stop platform 110 that is accessible by the advertiser 106 and an advertising medium proprietor 128, as discussed below.

An initial Step 302 of the method 300 comprises uploading, by one or more workers 108a-c, an advertisement-related service to a platform or a network. From the platform 110, the advertisement-related services are viewable by the advertiser 106. The advertisement-related services for offer can include a skill set of the worker, a fee for different services, a date of availability of the worker, and an availability of the worker to work in a region. These are standard worker parameters that the advertiser might find pertinent to implementing the advertising campaign. Another Step 304 can include listing, by the workers, at least one fee for implementing an advertisement. Each fee correlates to a specific skill set or type of advertisement, location of advertising medium, etc. Another Step 306 comprises including, by the worker, a cost adjustment for work-related variables outside control of the worker. For example, weather, or structural failures by the advertising medium may change the amount of work that needs to be performed and the cost of the work to be performed (workers may charge more during cold seasons or to work during thunderstorms). Yet another Step 308 is providing, by the worker, an estimated time-of-completion (the duration of time to complete the implementation of the advertisement). There are exceptions, however. For example, the worker can indicate conditions in which inclement weather during the scheduled work week prevents a painter from completing the advertisement. The worker indicates that additional work days will be performed at no charge following any inclement weather. A final Step 310 may include collecting, by the worker, a fee for the advertisement-related services. The fee may be a set price, or may be variable, depending on the external conditions around the advertising medium. For example, a worker may charge a certain amount to paint a billboard in two colors, a higher amount in four colors, etc.

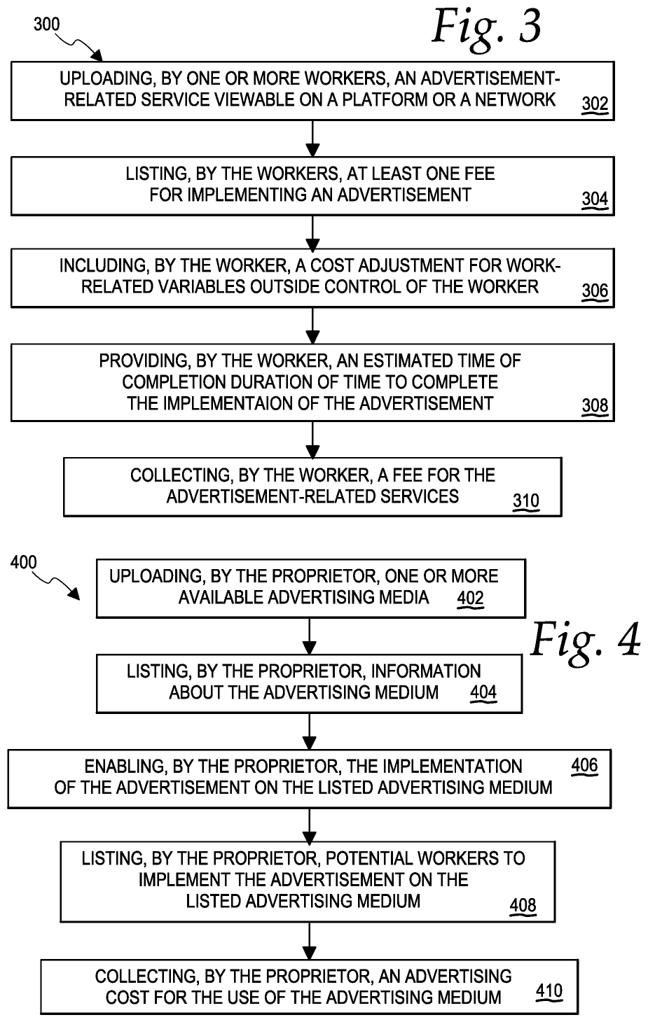

Turning now to method 400 in FIG. 4, the system 100 also allows an advertising medium proprietor 128 to have access to the platform 110. The advertising medium proprietor 128 is the owner or manager of the advertising medium 104a-c. In some embodiments, the proprietor 128 has an objective of offering for implementation of advertisements one or more advertising media. The proprietor 128 can also provide advertisement implementation solutions, i.e., workers, for the advertiser 106. The proprietor 128 has a further objective of collecting payment for use of the advertising medium 104a-c through the same one-stop platform 110 accessible by the advertiser 106 and the workers 108a-c.

An exemplary flowchart of a proprietor method 400 for application of the system 100, in offering an advertising medium 104a-c on a platform is referenced in FIG. 4. Similar to the workers, the proprietor 128 performs a Step 402 of uploading, by the proprietor, one or more available advertising media. The advertising media may include at least one non-digital advertising medium, such as a billboard, vehicle panel, park bench, building wall, and the like. A following Step 404 comprises listing, by the proprietor, information about the advertising medium. The information is detailed, and is viewable by the advertiser 106 and workers 108a-c through the platform 110. This information allows the advertiser 106 to select the most appropriate advertising medium 104a-c for the advertisement 102. In some embodiments, the advertising medium information may include, without limitation: a) Location; b) Size; c) Price; d) time and days available; e) Material Types; f) possible workers available to implement the advertisement on the advertising medium, i.e., print and stick or apply or mount.

After making the information available on the platform 110, a Step 406 includes enabling, by the proprietor, the implementation of the advertisement on the listed advertising medium. The proprietor 128 may perform the actual work of implementation, i.e., painting, assembling signage, etc. However, if the proprietor 128 is not directly implementing the advertisement, a Step 408 comprises listing, by the proprietor, potential workers to implement the advertisement on the advertising medium. The workers can either pay a fee to be listed on the platform, or the proprietor 128 can open the work for all advertising-related workers in the field. A final Step 410 includes, collecting, by the proprietor, an advertising cost for use of the advertising medium. Variables, such as type and location of advertising medium can be used to determine fees. Standard payment collections means may be applied through the platform 110.

The system 100 also allows for intelligent marketing capacity to assist the advertiser in optimizing the marketing budget and increase exposure of the advertisement. In this regard, the system 100 is unique in the integration of sensors and positioning systems in the advertising medium 104a-c.

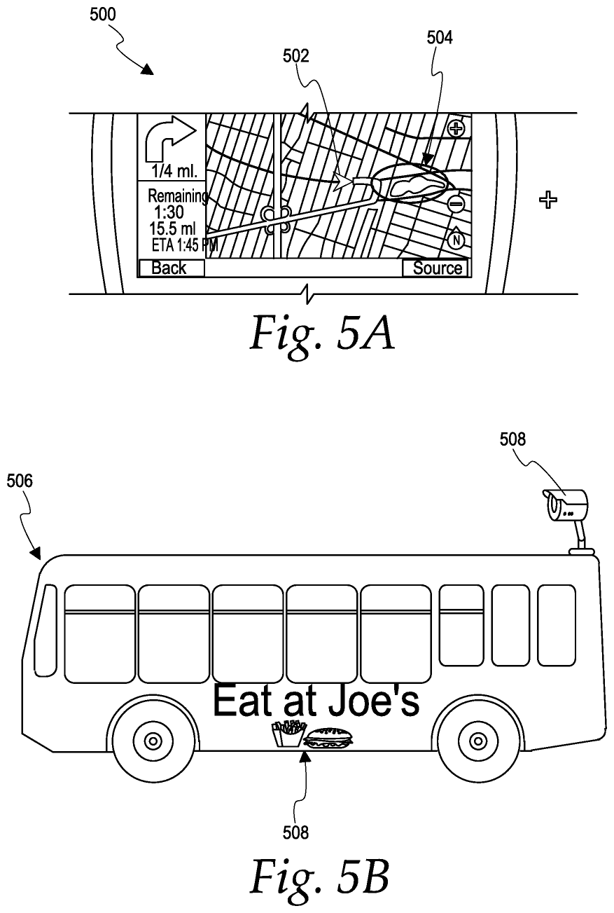

In one embodiment, at least one sensor 112 is integrated in the advertising medium 104a-c. The sensor 112 can be mounted to the advertising medium 104a-c through various fasteners, magnets, wires, and brackets. For example, as shown in FIG. 5B, a sensor 112 (camera) attaches to the bottom of a side billboard on a bus 506. The camera is positioned to detect consumers 114 within a 30 meter range from all directions relative to the bus 506.

Thus, from, the attachment point on the advertising medium 104a-c, the sensor 112 detects a plurality of consumers 114 in proximity to advertising medium 104a-c. The consumers 114 may include the general public, who are merely potential consumers 114 of the product or service being advertised. Or the consumers 114 may include people who are located in a confined space/building dedicated to purchasing a product or service. For example, the advertisement 102 is inside a grocery store, and the consumer who passes in proximity to the advertising medium 104a-c in the grocery store is likely to make a purchase.

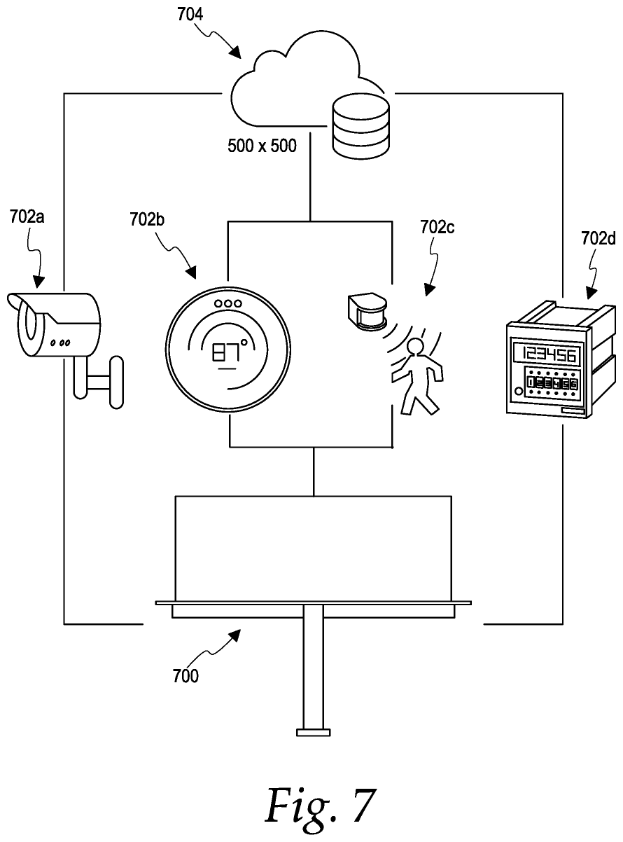

Looking ahead to FIG. 7, an advertising medium 700 not only carries an advertisement, butt also has integrated within, one or more sensors 702a-d configured to detect and record the physical features, relative position, and movement pattern of the consumers 114. The sensors 702a-d may include, without limitation, a camera 702a, a heat sensor 702b, a motion detector 702c, a counter 702d, and a microphone. The camera and sensors record motion, body heat, and physical presences of consumers and objects in proximity to the advertising medium 700. Yet another type of sensor is a processor that is operable with a facial recognition software. The facial recognition software detects and analyzes the faces of consumers who are proximal to the advertising medium.

In some embodiments, the sensor 112 affixes to an advertising medium 700 through various fastening means, including bolts, magnets, brackets, and simply being integrated into the advertising medium during manufacture. A database and/or processor 704 is operatively connected to the various types of sensors 702a-d. It is this processing capacity that allows for the synthesis of consumer data based on the recordings by the sensors.

Thus, any electrical sensor equipment that is attachable to the advertising medium 104a-c may be used as a sensor 112. For example, a counter 702d detects the number of consumers 114 passing within 10 meters of a park bench in an hour (assuming that the park bench is being used as an advertising medium). In another example, a camera 702a has integrated within a processor with facial recognition software to discern between male and female consumers driving past a billboard as well as to discern other demographic information, such as age, race, brand affiliation (discerned by looking for popular brand apparel or accessories), general fitness level as judged by body type, etc.

In other embodiments, the system 100 includes a positioning system 122 that is operable with the advertising medium 104a-c. The positioning system 122 may be utilized when the advertising medium 104a-c is mobile, such as a taxi, or other vehicle. The positioning system indicates the position of the moving advertising medium 104a-c in a region, and amongst the plurality of consumers 114. The positioning system 122 can be combined with a sensor 112, such as a camera, to determine the position of the advertising medium 104a-c relative to the consumers 114. This information is recorded to accumulate a consumer data 116, discussed below.

FIG. 5A references an exemplary global positioning system 500 integrated in a mobile advertising medium 502. The global positioning system 500 is operable to track the mobile advertising medium across a region. As illustrated, the mobile advertising medium 502 is moving in relation to a plurality of consumers 504 along a path. In one non-limiting embodiment, the mobile advertising medium 502 is a bus or a taxi with a signage printed across the side panels, or on a vehicle roof billboard. The advertisement is printed on the mobile advertising medium 502 in a prominent manner, so as to be viewable by the consumers 504 while driving by them. The position of the mobile advertising medium 502 is viewable, in relation to the consumers 504. This graphical position location allows the advertiser to know the status of the advertisement, and also allows the system to collect consumer data in real time, as the mobile advertising medium 502 passes different regions at different times.

FIG. 5B illustrates a bus 506 carrying a side panel advertisement 508 visible from the left side of the bus 506. The bus has integrated therein, a global positioning system tracker, and is operatively connected of a satellite and other GPS components known in the art. As discussed above, a sensor, such as a camera 508 integrates into the bus 506 to detect consumers in proximity to the bus. The camera 508 captures images of consumers, and transmits the data to a processor/database for synthesis to generate consumer data. Thus, both the position of the bus, and the characteristics of the consumers in the path of the bus 506 are detected and recorded for analysis. For example, the number of consumers potentially viewing the side panel advertisement 508 on the left side of the bus 506 are recorded during daylight hours and during nighttime hours. The consumer data is viewed by the advertiser to make pertinent advertising decisions.

The system 100 also provides the advertiser 106 with a consumer data 116 that is based on the consumers 114 who are near, or passing by the advertising medium 104a-c. The consumer data 116 is generated from the detection of the consumers 114 by the sensor 112 attached to the advertising medium 104a-c. For example, a camera records the number and frequency of consumers 114 passing by a billboard on a highway. The consumer data 116 may also be generated by the relative position of the advertising medium 104a-c to consumers 114 recorded by the positioning system 122. In another example, a GPS records the location of a taxi carrying an advertising board, in relation to consumers 114.

In one embodiment, the consumer data 116 is indicative of factors, which include: the numbers of consumers 114, the physical features of the consumers 114, the relative position of the consumers 114 to the advertising medium 104a-c, and the movement pattern of the consumers 114. It is known in the art that such information can help the advertiser 106 implement optimal marketing strategies through the advertising medium 104a-c. For example, the physical features of consumers may be detected with facial recognition software to determine the number of consumers 114 wearing glasses. The movement pattern of consumers is indicated by a camera that records the amount of time consumers 114 spend in front of a park bench. Other sensors 112 and positioning systems 122 can also be used to determine behavior of the consumers 114.

Once generated, the consumer data 116 is transmitted to a data storage unit 124 for storing and access by the advertiser 106. A processor 126 may also be used to store consumer data 116 and couple to a network interface, which enables communication with data storage unit 124, such as a database or a computer or telecommunications or internet network using an external connection shown generally as communication channel, which may be implemented as a hardwired or wireless communications link using suitable conventional technologies. With such a connection, processor 126 might receive information from the network, or might output information to a network in the course of performing the method steps described in the teachings of the present invention.

The system 100 also sets an advertising cost 118, which is the required payment to display the advertisement 102 on the advertising medium 104a-c. In some embodiments, the advertising cost 118 is based on multiple factors, including: the type of advertisement 102, the type and location of the advertising medium 104a-c, the working parameters 120 of the workers 108a-c, the duration of time that the advertisement 102 displays on the advertising medium 104a-c, and the characteristics of the collected consumer data 116.

In one example of how advertising costs are tabulated, an advertiser 106 chooses to advertise on two park benches and one taxi, for six months in a large city. The advertiser 106 requires a painter to draw the advertisement 102 on the park benches, and a vehicle body shop to paint the advertisement 102 on the taxi. The advertising cost factors all of these parameters to determine a final cost of $500, for example.

In alternative embodiments, the advertising cost 118 is affected by the consumer data 116. This is because the amount and type of consumers in proximity to the advertising medium—and thus the advertisement—can be a factor in determining whether the advertising campaign is a success or failure. For example, if large numbers of consumers 114 pass by the advertising medium 104a-c during the summer season, the advertising cost increases from June to September, and decreases from December to March. In some embodiments, a cost analysis algorithm, known in the art, may be used to analyze the advertising cost for the advertisement 102 based on the consumer data 116 and other factors discussed above. Thus, after viewing the advertising cost, the advertiser 106 selects and pays for the advertisement 102 on the platform 110.

It is also significant to note that the advertiser 106 discerns the effectiveness of the advertisement 102 based, at least partially, on the consumer data 116. The information collected by the sensor 112 is accessible by the advertiser 106. For example, the advertiser 106 discerns how many consumers 114, and the gender of consumers 114, passing the front side of a park bench painted with the advertisement 102. The advertiser 106 may then change the advertisement 102, or eliminate the entire advertising campaign based on this collected consumer data 116.

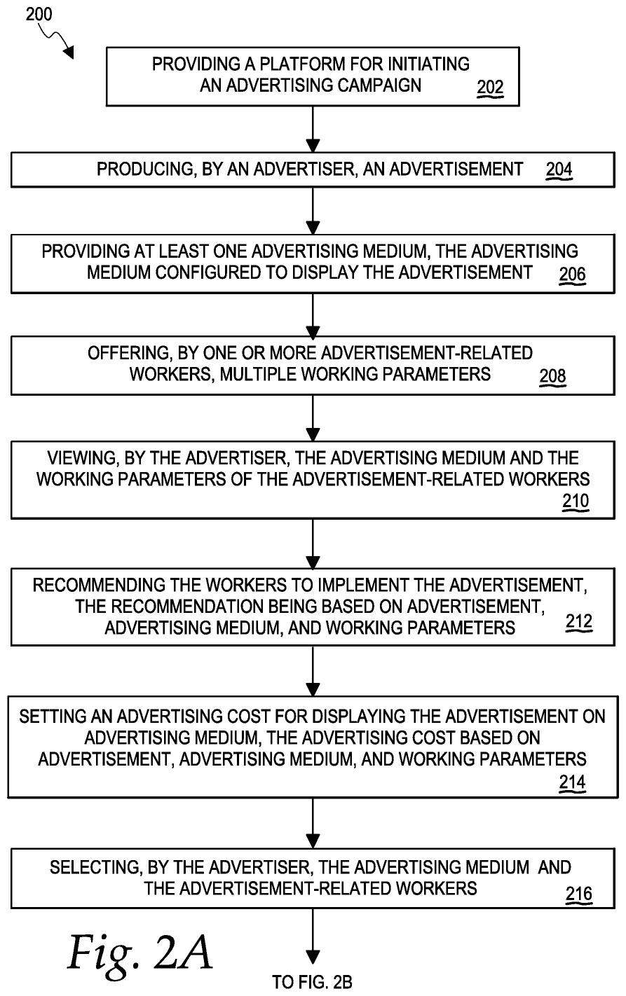

Turning now to FIGS. 2A-2B, a method 200 for implementing a one-stop advertising campaign through an advertising medium 104a-c comprises an initial Step 202 of providing a platform for initiating an advertising campaign. The platform 110 provides a single access point for selecting the advertising medium 104a-c, advertising-related workers 108a-c, advertising timeline, and advertising cost budgeting. Another Step 204 may include producing, by an advertiser 106, an advertisement 102. The advertisement 102 may include, for example, a corporate product or service for sale to the public or business. The advertisement 102 may have ornamental aspects, including various logos, trademarks, colors, and patterns.

Yet another Step 206 may include providing at least one advertising medium, the advertising medium configured to display the advertisement. In one non-limiting embodiment, the advertising medium 104a-c comprises a non-digital advertising medium. In some, the non-digital advertising medium may include, without limitation, a billboard, a bench backrest, a vehicle, and a building.

The method 200 also includes a Step 208 of offering, by one or more advertisement-related workers, multiple working parameters. In some embodiments, the one or more advertisement-related workers 108a-c may include, without limitation, a printer, a painter, a sign worker, a digital sign programmer, and a sensor installation technician. In some embodiments, the working parameters 120 of the advertisement-related workers 108a-c may include, without limitation, a skill set, a fee, a date of availability schedule, and an availability in a region. Other parameters that affect the services of the advertising medium may also be included.

In some embodiments, a Step 210 comprises viewing, by the advertiser, the advertising medium and the working parameters of the advertisement-related workers 108a-c. The advertiser 106 may view from the platform 110, a plurality of advertising media having different configurations and located in different regions. Another Step 212 includes recommending one or more of the advertisement-related workers 108a-c to implement the advertisement 102, the recommendation being based, at least partially, on the advertisement 102, the advertising medium 104a-c, and the working parameters 120 of the advertisement-related workers 108a-c.

In yet another embodiment of the method 200 a Step 214 includes setting an advertising cost for displaying the advertisement on the advertising medium, the advertising cost being based, at least partially, on the advertisement, the advertising medium, and the working parameters of the advertisement-related workers. In general, the number and type of advertising medium 104a-c, the region of the advertising medium 104a-c, and the number and type of consumers 114 in proximity to the advertising medium 104a-c, substantially dictate the advertising cost. The advertiser 106 is given different baskets of advertising costs, depending on the selected advertising medium 104a-c and advertisement-related workers 108a-c.

Another Step 216 comprises selecting, by the advertiser, the advertising medium and the one or more advertisement-related workers. The selection is performed from the platform 110. This can include clicking from multiple check boxes or drop boxes on a graphical user interface. The method 200 further comprises a Step of scheduling, by the advertiser 106, a timeline for displaying the advertisement 102 on the advertising medium 104a-c. The advertiser 106 also has the option to select the duration of the advertisement 102. For example, a six-month period to advertise on a billboard is possible. Similar to selecting the advertising medium 104a-c and the workers 108a-c, the selection of a desired timeline is performed on the platform 110.

In some embodiments, the method 200 further comprises a Step of paying, by the advertiser, the advertising cost. Payment may be performed on the platform 110. Yet another Step 218 comprises displaying the advertisement 102 on the advertising medium 104a-c. The advertiser 106 may, for example, upload, from the platform 110, an advertisement 102 to display on the selected advertising medium 104a-c, and with the selected one or more advertisement-related workers 108a-c.

The method 200 may also include a Step 220 of integrating a sensor in the advertising medium. The sensor 112 is configured to recognize the type, number, and moving pattern of the potential consumers 114. Eclectic typers of sensors may be used, so as to create an intelligent advertising medium 104a-c, generally non-digital before integration of the sensor 112. In some embodiments, the sensor 112 may include, without limitation, a counter, a motion detector, a camera, a microphone, and a processor operable with a facial recognition software.

In an additional embodiment, a Step 222 comprises detecting, with the sensor, one or more consumers relative to the advertising medium. The sensor 112 may utilize motion, body heat, speed, and facial recognition software to record the potential consumers 114. A processor and a marketing algorithm may further synthesize the collected information from the consumers 114 to generate a consumer data 116, as discussed below. In an another embodiment, the method 200 includes a Step 224 of generating, from the detected consumers 114, a consumer data 116, the consumer data 116 being indicative of the numbers, physical features, relative position, and movement pattern of the consumers 114. The consumer data 116 may be sold, or synthesized for marketing purposes.

In another possible embodiment of the method 200, a Step 226 includes setting an advertising cost for displaying the advertisement on the advertising medium, the advertising cost being based, at least partially, on the advertisement, the advertising medium, the working parameters of the advertisement-related workers, and the consumer data.

The method 200 further comprises a Step 228 of integrating a positioning system in the advertising medium. The positioning system 122 may include a global positioning system (GPS). This is followed by a Step of detecting, with the positioning system 122, one or more consumers 114 relative to the advertising medium 104a-c. Thus, as an advertising medium 104a-c, such as a taxi cab, moves through a region, the advertising cost increases or decreases based on variable from the consumer consumer.

The method 200 also comprises a Step 230 of monitoring, by the advertiser, the consumer data. The advertiser 106 is given access to the consumer data 116 for further synthesis and dissemination. In this manner, the advertiser 106 can perform a final Step 232 of discerning the effectiveness of the advertisement 102 based on the consumer data 116. The effectiveness of the advertisement 102, in marketing terms, may include converting a percentage of potential consumers 114 near the advertising medium 104a-c into actual consumers 114.

Effectiveness may also be defined as increasing sales during the duration of the advertising campaign. For example, the advertiser 106 discerns the number of consumers 114, and the gender of the consumers 114 who pass by the front side of a park bench that is painted with the advertisement 102. Based on this consumer data 116, the advertiser 106 can change the advertisement 102, or eliminate the entire advertising campaign if found to be ineffective.

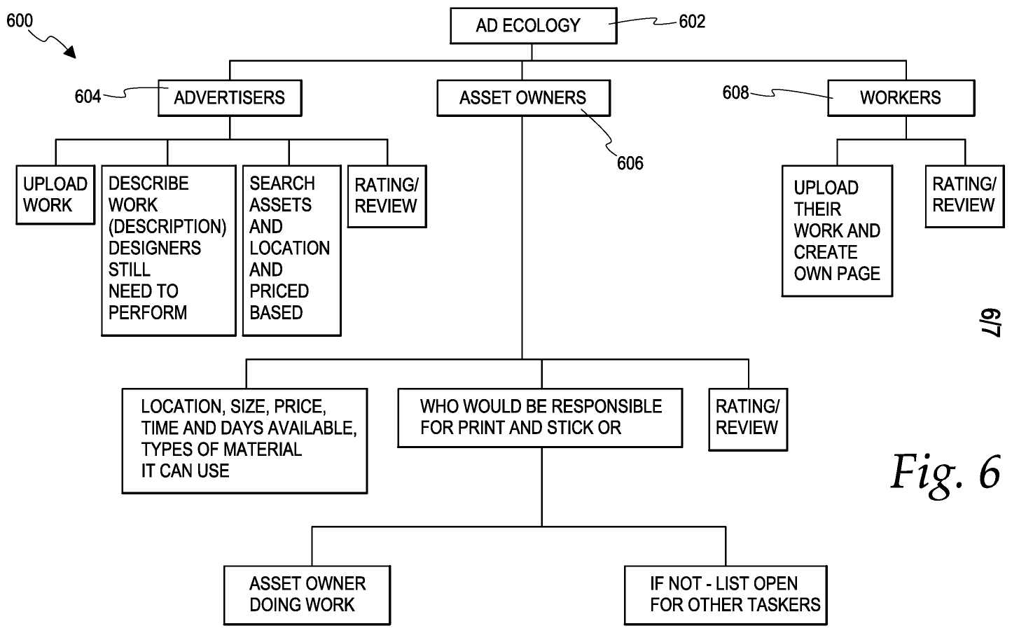

FIG. 6 references an exemplary schematic diagram of a system 600 for integrating the advertiser, workers, and proprietor on a single one-stop platform. This creates a synergistic Advertisement Ecology 602 for each party. As illustrated, an advertiser 604 initially uploads the desired advertisement that requires implementation onto the platform. The uploading can be performed through a website, software application, or other network. The advertisement being uploaded can include a graphical depiction of the advertisement. The advertiser 106, at this point, describes the work that is required, and the type of advertisement being implemented. The advertiser 106 may then search the platform for an appropriate advertising medium. The search is performed on the platform 10, and may include a graphical depiction of all regions in which advertising media are available; a description of the type/material of advertising medium; and past consumer information near the advertising medium, i.e., a bar chart showing the number of potential consumers passing the selected advertising medium at different times of the day. The advertiser 106 then proceeds to select workers for implementing the advertisement, as desired. Finally, after completing the advertisement implementation, and experiencing positive or negative sales results, the advertiser 106 may post a review of the advertising medium 104a on a network. The review can be a 1-5 star review, a comment, or other reviewing means known in the art of review. An exemplary review may read, “The painter did a beautiful job with our logo. And when it rained that week, the painter worked extra days without charging me additional fees”.

Continuing with the system 600 for integrating the advertiser, workers, and proprietor on a single one-stop platform, an advertising medium proprietor 128 also has access to the platform 110. The advertising medium proprietor 128 is the owner or manager of the advertising medium 104a-c. The proprietor 128 has an objective of presenting, and collecting payment for use of the advertising medium 104a-c through the same one-stop platform 110 accessible by the advertiser 106 and the workers 108a-c. The proprietor 128 uploads, or presents in another manner, the selection of available advertising media. An advertiser on the same platform may then select and pay for access to one or more of the advertising media. As depicted in diagram FIG. 6, the proprietor 128 then has the option of implementing the advertisement, or listing one or more advertising-related workers who can perform this function. The proprietor 128 may either open the jobs to all workers in the market, or select from a few workers. The proprietor 128 may even charge the workers a fee to be listed for accessing and being made available to advertisers.

Continuing with the diagram, one or more advertisement-related workers 108a-c may also access the platform 110, and thereby, be viewed by, and communicate with the advertiser 106 and the proprietor 128. The workers 108a-c are operable to implement the advertisement 102 on the non-digital advertising medium in an efficient manner, and as the advertiser 106 requires. The workers 108a-c offer multiple working parameters 120 viewable on the platform 110, or a network accessed by the advertiser, such as a skill set, a fee, a date of availability schedule, and an availability in a region. The workers 108a-c upload these working parameters 120 to the platform and/or network in order to be selected for implementation of the advertisement on a selected advertising medium. And similar to the advertiser 106, the workers 108a-c can post reviews about the job. This can include a review or criticism of the advertising medium, proprietor 128, and advertiser. This can also include advice to other workers about the best means for applying the advertisement, and warnings about a specific advertising medium. An exemplary review may read, “The advertiser paid me on time. But the billboard on highway 1A has a slippery ladder. Be careful!”.

In conclusion, a system 100 and method 200 for implementing a one-stop advertising campaign through a non-digital advertising medium provides a single platform 110 for an advertiser 106 to implement an advertisement 102 on a non-digital advertising medium. The advertiser 106, through a one-click functionality on the platform 110, selects the advertising medium 104a-c, the advertising-related workers 108a-c to implement the advertisement 102, the advertising costs 118, and the timeline for advertising on the advertising medium 104a-c.

Further, one or more advertising-related workers 108a-c upload skill sets and fees for the advertiser 106 to review before selecting. The system 100 generates recommendations of appropriate workers 108a-c to implement the advertisement 102 campaign based on needs of the advertiser 106. The system also integrates sensors and/or positioning systems into the advertising media to detect the numbers, physical features, relative position, and movement pattern of consumers 114 in proximity to the advertising medium 104a-c. This allows a processor 126 and algorithms to generate consumer data 116 useful to the advertiser 106 for marketing and setting advertising costs 118.

The preceding description of the disclosure has been presented for purposes of illustration and description and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification, but be defined by the claims set forth below. In addition, although narrow claims may be presented below, it should be recognized that the scope of this disclosure is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional disclosures are not dedicated to the public and the right to file one or more applications to claim such additional disclosures is reserved.

What is claimed is:

1. A method for implementing a one-stop advertising campaign through an advertising medium, the method comprising:
producing, by an advertiser, an advertisement;
providing at least one advertising medium, the advertising medium configured to display the advertisement;
offering, by one or more advertisement-related workers, multiple working parameters;
viewing, by the advertiser, the advertising medium and the working parameters of the advertisement-related workers;
recommending one or more of the advertisement-related workers to implement the advertisement, the recommendation being based, at least partially, on the advertisement, the advertising medium, and the working parameters of the advertisement-related workers;
setting an advertising cost for displaying the advertisement on the advertising medium, the advertising cost being based, at least partially, on the advertisement, the advertising medium, and the working parameters of the advertisement-related workers;
selecting, by the advertiser, the advertising medium and the one or more advertisement-related workers; and
displaying the advertisement on the advertising medium.

2. The method of claim 1 wherein, the advertising medium comprises at least one non-digital advertising medium.

3. The method of claim 2 wherein, the non-digital advertising medium includes at least one of the following: a billboard, a bench backrest, a vehicle, and a building.

4. The method of claim 1 wherein, the working parameters of the advertisement-related workers include at least one of the following: a skill set, a fee, a date of availability schedule, and an availability in a region.

5. The method of claim 1 wherein, the one or more advertisement-related workers include at least one of the following: a printer, a painter, a sign worker, a digital sign programmer, and a sensor installation technician.

6. The method of claim 1 further comprising a step of paying, by the advertiser, the advertising cost.

7. The method of claim 1 further comprising a step of scheduling, by the advertiser, a timeline for displaying the advertisement on the advertising medium.

8. The method of claim 1 further comprising a step of integrating a sensor in the advertising medium.

9. The method of claim 8 further comprising a step of detecting, with the sensor, one or more consumers relative to the advertising medium.

10. The method of claim 9 further comprising a step of generating, from the detected consumers, a consumer data, the consumer data being indicative of the numbers, physical features, relative position, and movement pattern of the consumers.

11. The method of claim 10 further comprising a step of monitoring, by the advertiser the consumer data.

12. The method of claim 11 further comprising a step of discerning the effectiveness of the advertisement based on the consumer data.

13. The method of claim 12 further comprising a step of setting an advertising cost for displaying the advertisement on the advertising medium, the advertising cost being based, at least partially, on the advertisement, the advertising medium, the working parameters of the advertisement-related workers, and the consumer data.

14. The method of claim 8 wherein, the sensor includes at least one of the following: a counter, a motion detector, a camera, a microphone, and a processor operable with a facial recognition software.

15. The method of claim 1 further comprising a step of integrating a positioning system in the advertising medium.

16. The method of claim 15 further comprising a step of detecting, with the positioning system, one or more consumers relative to the advertising medium.

17. The method of claim 1 further comprising a step of selecting, by the advertiser, the advertising medium and the one or more advertisement-related workers, the selections being performed from a platform.

18. A method for implementing a one-stop advertising campaign through an advertising medium, the method comprising:
producing, by an advertiser, an advertisement;
offering, by a proprietor, at least one advertising medium, the advertising medium configured to display the advertisement;
integrating a sensor in the advertising medium;
offering, by one or more advertisement-related workers, multiple working parameters;
viewing, by the advertiser, the advertising medium and the working parameters of the advertisement-related workers;
recommending one or more of the advertisement-related workers to implement the advertisement, the recommendation being based, at least partially, on the advertisement, the advertising medium, and the working parameters of the advertisement-related workers;
setting an advertising cost for displaying the advertisement on the advertising medium, the advertising cost being based, at least partially, on the advertisement, the advertising medium, the duration of time the advertisement displays on the advertising medium, and the working parameters of the advertisement-related workers;
selecting, by the advertiser, the advertising medium and the one or more advertisement-related workers, the selection being performed from a single platform;
paying, by the advertiser, the advertising cost;
displaying the advertisement on the advertising medium,
detecting, with the sensor, one or more consumers relative to the advertising medium;
generating, from the detected consumers, a consumer data, the consumer data being indicative of the numbers, physical features, relative position, and movement pattern of the consumers;
monitoring by the advertiser the consumer data; and
discerning the effectiveness of the advertisement based on the consumer data.

19. The method of claim 18 wherein, the advertising medium comprises at least one non-digital advertising medium.

20. A system for implementing a one-stop advertising campaign through a non-digital advertising medium, the system comprising:
a platform accessible by an advertiser to implement an advertising campaign;
an advertisement produced by the advertiser;
one or more advertising mediums, including at least one non-digital advertising medium, the advertising medium configured to display the advertisement;
one or more advertisement-related workers operable to implement the advertisement on the advertising medium, the advertisement-related workers providing multiple working parameters, the working parameters including at least one of the following: a skill set, a fee, a date of availability schedule, and an availability in a region;
a sensor integrated in the advertising medium, the sensor being operable to detect the physical features, relative position, and movement pattern of multiple consumers;
a consumer data being generated from the detection of the consumers by the sensor, the consumer data being indicative of the numbers, physical features, relative position, and movement pattern of the consumers;
an advertising cost being set for displaying the advertisement on the advertising medium, the advertising cost being based on the advertisement, the advertising medium, the working parameters of the advertisement-related workers, the duration of time the advertisement displays on the advertising medium, and the consumer data;
whereby the advertiser selects and pays for the advertisement on the platform; and
whereby the advertiser discerns the effectiveness of the advertisement based, at least partially, on the consumer data.
